(19) United States
(12) Patent Application Publication
(10) Pub. No.: US 2025/0060754 A1
(43) Pub. Date: Feb. 20, 2025

(54) METHOD AND SYSTEM FOR NAVIGATING AN AUTONOMOUS VEHICLE IN AN OPEN-PIT SITE

(71) Applicant: UNIVERSIDAD DE CHILE, Santiago (CL)

(72) Inventors: Javier RUIZ DEL SOLAR SAN MARTÍN, Santiago (CL); Daniel HERRMANN PRIESNITZ, Santiago (CL); Sebastián Isao PARRA TSUNEKAWA, Santiago (CL); Mauricio CORREA PÉREZ, Santiago (CL)

(21) Appl. No.: 18/723,823

(22) PCT Filed: Dec. 24, 2021
(86) PCT No.: PCT/IB2021/062307

§ 371 Date: Jun. 24, 2024

(51) Int. Cl. G05D 1/246; G05D 107/70; G05D 111/50

(52) U.S. Cl. CPC G05D 1/2469; G05D 2107/73; G05D 2111/54

(57) ABSTRACT

Method and system for navigating an autonomous vehicle in an open-pit site. The method involves acquiring multiple observations and odometry data from various poses while driving, accessing a topological map of the site with intersections and segments; accessing an observational map of the site with past observations including surroundings information linked to an intersection or segment, processing past observations, acquired observations, and odometry data, applying particle filtering techniques and Gaussian Processes to model observations from discrete poses as a continuous variable and estimate the current pose, statistically predicting the next pose based on the current direction of movement; commanding the autonomous vehicle via actuators controlled by the processor unit, based on detecting whether the vehicle is in a segment or intersection, and issuing either a moving-forward instruction to traverse the segment or a steering instruction to take a subsequent segment.

### FIELD

The present disclosure generally describes a method and a system for achieving autonomous driving of vehicles in open-pit sites, like open-pit mines, without using any Global Navigation Satellite System. More particularly, it relates to autonomous driving using alternatives to Global Navigation Satellite Systems.

### BACKGROUND

Robotics and automation technology is attracting interest from the mining industry. For instance, the use of autonomous haulage trucks is increasing worldwide due to the impact in reducing operation costs and increasing workers safety. In an open-pit mine, many mining operations like digging, excavating and transporting materials would benefit from this technology. However, automating mining vehicles is challenging, because the mining environment is harsh, it is continuously changing, and it is dirty and bumpy.

Currently, most self-driving solutions rely on Global Navigation Satellite Systems (GNSS) to determine the position of a vehicle and to associate the position with the surroundings. The most common GNSS is the Global Positioning System (GPS), although other alternatives exist, like Galileo, Glonass and Beidou.

Unfortunately, solutions based on GNSS have a problem of robustness. The GNSS signals may be interfered with by atmospheric disturbances, large buildings, canyons or power lines. In particular, ionospheric scintillations, which are atmospheric phenomena caused by solar activity, causes interruptions in satellites communications. When an autonomous vehicle loses GNSS signal, it must stop as a cautionary measure. Afterwards, it needs be restarted with human intervention. Such a situation involves a high cost in the context of an open-pit mine and is not unusual. For instance, in northern Chile, almost all of the Chilean copper open-pit mines are located in a zone suffering from ionospheric scintillations. Therefore, there is a current need for new technology solutions to deal with situations where GNSS technology is not reliable.

The determination of the position and orientation (pose) of a vehicle, which in the robotics literature is known as self-localization, is essential for its autonomous navigation.

The self-localization of a vehicle inside a mining pit without using any GNSS information is challenging because of the highly symmetry of the environment, which causes that different sensors (e.g. cameras) obtain similar measurements in different positions of the pit. Therefore technologies to address this challenge are needed.

Solutions developed for autonomous vehicles moving along cities or highways are not applicable to open-pit environments. For instance, prior art document US2019146500 A1 discloses autonomous vehicle self-localization techniques using particle filters and visual odometry for place recognition into a digital map in near real-time. The routes within the map can be characterized as a set of nodes, which can be augmented with feature vectors that represent the visual scenes captured using camera sensors and can be constantly updated on the map server and then provided to the vehicles driving the roadways. These techniques are discrete (images are taken at some fixed positions) and unsuitable for an open-pit site like an open-pit mine, taking into account that any visual place recognition would not work in such environment, due to the similarity of the different visual images acquired on the pit wall.

Prior art document SE201950554 discloses techniques for road shape estimation for an ahead driving path of an autonomous vehicle. The method includes the steps of obtaining sensor values concerning the vehicle surroundings and establishing a road model of the ahead road comprising a number of waypoints of the ahead road by linear mapping of the road model, based on the obtained sensor values. Similar as the case of document US2019146500 A1, these techniques are discrete and unsuitable for an open-pit site due to similarity of such an environment.

### SUMMARY

The present invention was made in view of the shortcomings of the state of the art in autonomous navigation in GNNS-denied environments, and addresses the demanding need for robustness in autonomous vehicles operating in open-pit sites. In particular, an open-pit site may comprise an open-pit mine, a construction site, and other related work-sites. An open-pit site is composed of paths and junctions to be modeled as segments and intersections respectively. Especially, the invention is applicable for any opent-pit site that has an associated topological map, such as open-pit mines and other areas or zones having paths and junctions which can be modeled and represented in that topological map.

The present invention aims at a method and a system as defined by the independent claims. Several advantageous embodiments are defined in the dependent claims.

According to the invention, a vehicle may navigate an open-pit site in a robust way using an alternative to GNNS. The routes in the open-pit site are represented using a model with segments and intersections and neighborhood relations between these elements. An aspect of the invention relies on a proper detection of intersections. Advantageously, the invention avoids collisions within each segment (e.g. wall), and avoid falling into the cliff, without requiring a precise location and by just moving along the segment at a safe distance (range) from the walls. The invention uses an observation map. The observation map stores surroundings information collected by sensors (like an odometer, a LIDAR, an altimeter, a magnetometer, a gyroscope, etc.) in discrete positions within each segment and each intersection.

The observation map is accessed to self-localize the vehicle within each segment. Due to the use of Gaussian processes, the vehicle's pose can be appropriately estimated by comparing the current observations with the observations stored in the map. The use of Gaussian processes allows treating the sensors data, acquired in discrete positions, as data acquired in continuous positions. This is because Gaussian Processes estimate the mean and covariance of a data series in time or space (modeled as random variables) by incorporating prior knowledge (kernels) in the estimation. This represents a technical advantage because if allows to increase the accuracy of the comparisons between the current observations and the stored observations, which can be managed as continuous variables.

### BRIEF DESCRIPTION OF THE DRAWINGS

FIG. 1 illustrates an ionospheric scintillations map and the frequency of occurrence.

FIG. 2 illustrates an example of a pit modeled by segments (lines) and intersections (circles).

FIG. 3 illustrates an example of the block diagram of the proposed system for navigating a vehicle in an open-pit site.

FIG. 4 illustrates a proposed orientation of laser sensors on a vehicle.

FIG. 5 illustrates a correspondence between a picture of an open-pit mine and a topological map with segments (dotted lines) and intersections (continuous lines).

FIG. 6 illustrates a particular example of a topological map.

FIG. 7 illustrates a detailed flow diagram of an aspect of the proposed method.

FIG. 8A illustrates a prior art movement prediction with a traditional particle filter technique.

FIG. 8B illustrates movement prediction with a proposed particle filter technique.

FIG. 9 illustrates a place in the Laguna Carén Park where a prototype was tested.

### REFERENCE NUMBERS

10 Topological map.
11 Segment.
12 Intersection.
20 Observation map.
30 Vehicle.
31 Sensors.
32 Actuator.
33 Processor unit.
34 Global localization module.
35 Intersection navigation module.
36 Local localization module.
37 Segment navigation module.
38 Multiplexor.
39 Intersection detector module.
72 Acquisition step.
74 Topological information gathering step.
76 Observational gathering step.
78 Processing step.
79 Commanding step.

### DETAILED DESCRIPTION

Several aspects and embodiments of the present invention will be explained with reference to the appended drawings for a better understanding. Particularly, a method and a system for navigating an autonomous vehicle are presented. The present invention is suitable for autonomous vehicles operating in open-pit sites, like open-pit mines without the need of GNSS.

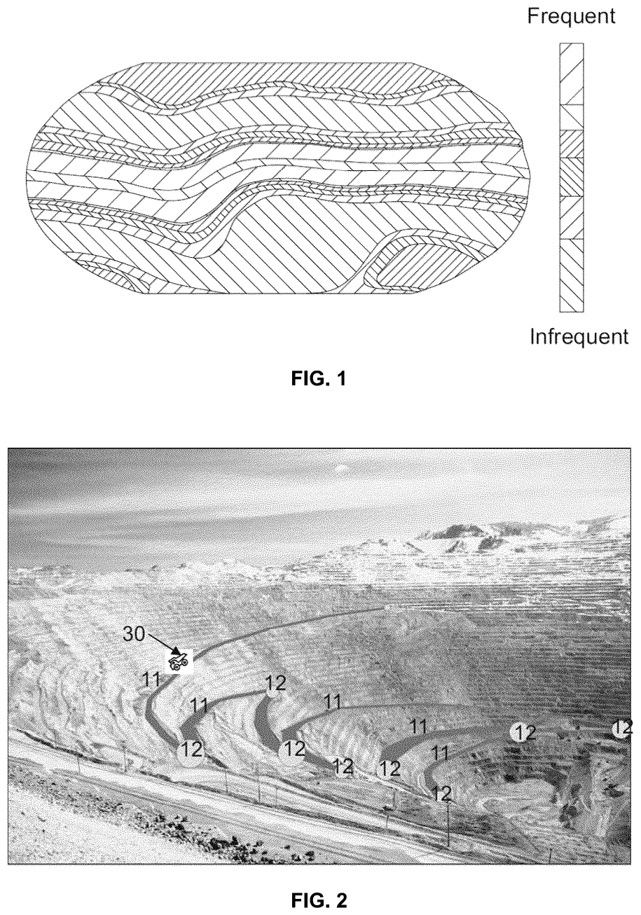

FIG. 1 shows several world fringes affected by ionospheric scintillations in various degrees. Important mining regions, where the present invention can be helpful, are located within the most affected fringe where GNSS technology may fail.

FIG. 2 illustrates a photograph of an open-pit mine with an overprinted representation of a model. The road network of the open-pit mine is modeled as a graph. The graph is composed of segments 11 represented by lines, intersections 12 (or nodes) represented by circles. This information may serve to build a topological map. The topological map requires local spatial coherence. For local spatial coherence is meant that the topological map reflects geometrical relationships such as a set of neighborhoods relationships among segments, intersections and combinations thereof.

A vehicle 30 can move along a segment 11 that corresponds to a path or lane or the like. An intersection 12 corresponds to a place in which the vehicle can either change to another segment 11 (e.g. a junction) or can perform certain operations, like going out of the pit or loading material (e.g. a working area).

When a vehicle 30 travels along a segment 11, it is only allowed to move forward staying within its boundaries to avoid crashing into a wall or falling off a cliff. While traversing a segment 11, the exact longitudinal position of the vehicle is less relevant. Consequently, a highly precise localization estimation is not required, and less precise self-localization methods can be used.

On the other hand, when a vehicle 30 is approaching an intersection 12, it is key to correctly decide which of the different segments to take and consequently make the appropriate maneuvers. Thus, self-localization in intersections may demand higher precision.

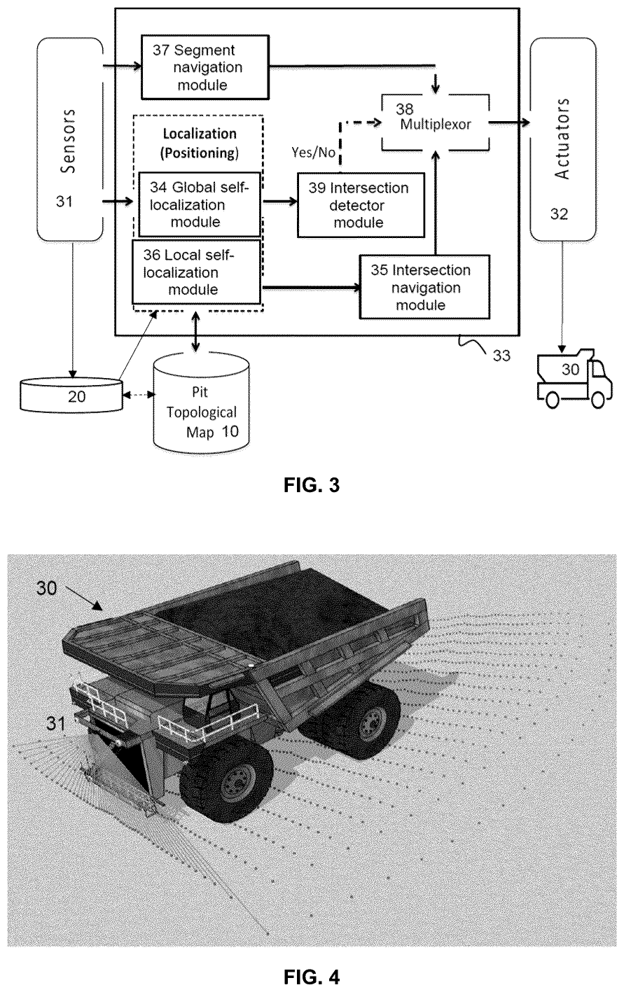

FIG. 3 illustrates a block diagram showing several components of a system for navigating a vehicle in an open-pit site. A processing unit 33 receives inputs from sensors 31 and produces outputs for actuators 32 to drive or operate the vehicle 30. Sensors 31 gather surroundings information. Sensors 31 are required to directly or indirectly measure distance (e.g., 2D or 3D laser, radar, video camera), the movement of the vehicle 30 (e.g., Inertial Units) or other variables (e.g., slope, height of surroundings).

The topological map 10 includes topological information like neighborhoods relationships among segments and intersections of the graph representing the open-pit site.

An observation map 20 includes surroundings information, such as sensors data for each segment and for each intersection of the topological map 10.

The sensor data is used by a local self-localization module 36 to locally estimate the vehicle's pose within a particular segment or intersection, that is its local pose comprising position and orientation of the vehicle within a certain segment or intersection, which defines a local position and a local orientation.

A global self-localization module 34 obtains in which particular segment or intersection of the pit the vehicle is located. Thus, sensor data acquired while driving can be associated to a segment or intersection.

A segment navigation module 37 controls the vehicle's displacement along each segment, avoiding collisions. The segment navigation technique is principally reactive, that means, it is based on the sensors data for following a route without colliding with an obstacle. In this case in particular, traversing a segment while driving within segment boundaries. Consequently, the target is not to collide with the pit wall and not to fall into the cliff while moving forward. Advantageously, the navigation along segments does not require planning a path/route, as opposed to a deliberative navigation. In fact, a deliberative navigation usually requires knowing a target destination, and generating a trajectory or path free of obstacles to the target destination. Despite being probably more accurate, the deliberative navigation is more complex and computationally expensive.

An intersection detector module 39 compares the observations currently obtained by the sensors 31, with the ones stored in the observation map 20, and determines if the vehicle is at the end of a segment, and then if it is approaching to an intersection. Then, once in the intersection, considering the target to which the vehicle is going and utilizing the topological map 10, some maneuvers are made by means of the actuators 32 to take the appropriate subsequent segment.

An intersection navigation module 35 is used to control these vehicle maneuvers in the intersections, in order to take the new segment.

The intersection detector module 39 determines the selection of which navigation module 35, 37 is the one in charge to send the controls orders (navigation) to the actuators 32 of the vehicle 30. This selection is controlled using a multiplexor 38. There are two specific navigation modules because each one works under different conditions.

Actuators 32 command the vehicle to accelerate, brake, steer, etc. according to the navigation modules 35, 37.

The processing unit 33 generates actuators commands to drive the vehicle 30 along the segment and avoid collisions.

FIG. 4 illustrates an embodiment where a vehicle 30, a haulage truck, with laser sensors 31 mounted in vertical orientation in the front section. In this embodiment, laser sensors 31 are capable of bidimensional (2D) scanning a vertical surface profile. The laser sensors 31 measurements allow to calculate the distance to the wall and the ravine, and by storing an accumulation of measurements, the processing unit is capable of recurrently estimating a local pose with relative orientation and position of the vehicle 30 within a certain segment or intersection, as well as to avoid collisions with the walls.

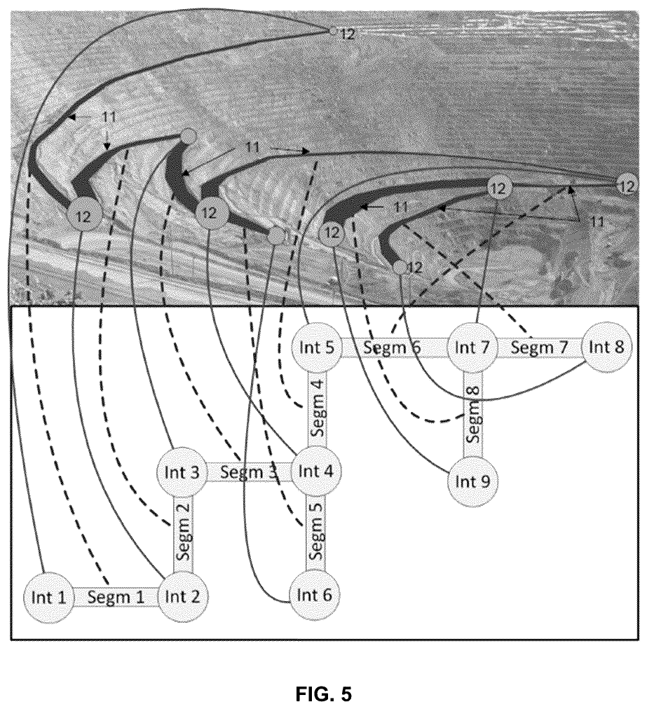

FIG. 5 illustrates an example of correspondence between a picture of an open-pit mine and its graph representation with segments 11 (dashed lines) and intersections 12 (continuous lines).

The topological map includes the following information.

For each segment 11:
List of entries/exits, internal positions of them, and intersections connected to each entry/exit.
Length of the segment.
Links or connections to surroundings information of the segment (stored in the map of observations).

For each intersection 12:
List of entries/exits, internal positions of them, and segments connected to each entry/exit.
Length of each internal lane when traversing between each pair of possible entry/exit.
Links or connections to surroundings information of the intersection (stored in the map of observations).

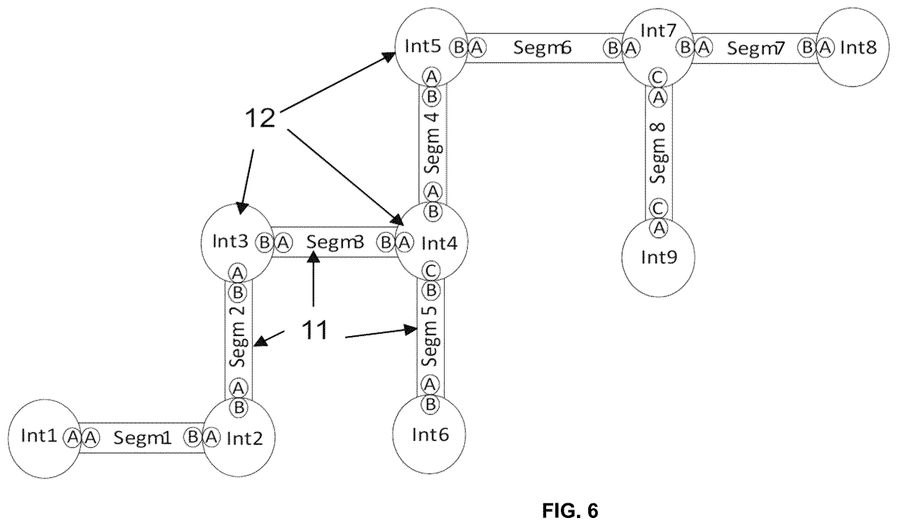

FIG. 6 shows an example of a topological map 10 where segments 11 and intersections 12 include a unique identification “Int #” or “Segm #”. The entries and exits of intersections 12 are associated to entries and exits of segments 11. Entries or exits are noted with letters A, B, C, . . . . Intersections may have one or more entries or exits. For instance, intersection “Int 4” includes three entries or exits: “A”, “B” and “C”; whereas intersection “Int 9” includes one entry or exit: “A”. On the other hand, segments only have two entries or exits: “A” and “B”.

### Global and Local Self-Localization

The pose of the vehicle refers to position and orientation. The pose is divided in two components, a global pose and local pose (internal to each segment or intersection).

The global pose is given by the specific intersection or segment where the vehicle is currently navigating. For example, if a vehicle is navigating through segment Segm 3, between intersections Int 3 and Int 4, the global pose is simply defined as “Segm 3”. If a vehicle is in Int 4, the global pose is simply defined as Int 4. The global pose does not include orientation information. Just the local pose comprises orientation information.

On the other hand, the local pose is defined as the position and orientation of the vehicle in the local reference system of the current segment or intersection. For segments, the local pose of the vehicle is defined by a distance and a movement direction of the vehicle with respect to the local reference system of the segment. In intersections the local pose is defined by the “X” and “Y” coordinates, and the orientation of the vehicle with respect to the local reference system of the intersection. Notice that each segment and intersections has its own local reference system. This approach has technical advantages, it requires less computational resources and it allows avoiding the accumulation of errors. This is because those previous errors generated in past segments or intersections do not accumulate when entering in a subsequent segment or intersection. Consequently, in order to achieve a valid local pose for the vehicle, a less demanding precision and accuracy is needed. As a result, it eases computing specifications and saves processing power.

To enable the self-localization of the vehicle, prior knowledge of its environment is needed. A comparison of the current observations with past observations serves to characterize the place. Past observations are stored in an observation map. An observation comprises surroundings information mainly acquired using sensors, which allow differentiating places within a segment or an intersection.

Several types of sensors may be used to obtain the required surroundings information:
Sensors allowing to measure features of the pit's wall and to recognize intersections. In particular, range sensors (laser or radar) and/or video cameras are suitable sensors for these tasks. In an exemplary embodiment, a two-dimensional (2D) laser sensor could be mounted in a vertical orientation at the front part of the vehicle, as it is shown in FIG. 4.
Altimeters for sensing the height of a given position within a segment.
Electronic compass for sensing a local curvature.

Furthermore, accelerometers, gyroscopes, and inertial measurement sensors allow estimating the local movements of the vehicle.

Even though, only one sensor does not allow to robustly determining the vehicle's pose, a collection of different sensors does. For instance, laser sensors, accelerometers, gyroscopes, electronic compasses and altimeters can be used together. Alternatively, measurement data obtained by laser sensors may be complemented or even replaced by the use of radar data or images acquired using monocular or binocular cameras. However, it must be stressed that the use of just images does not allow solving the self-localization problem by itself, due to the highly symmetry of the of the pit's walls. Images need to be used together with other sensors.

By combining the information stored in the observation map and the current observations/measurements obtained from sensors, the vehicle's pose (position and orientation) is determined.

The techniques used to determine vehicle's pose involves a state estimation algorithm that estimates a non-measurable internal state of a specific dynamic system. Assuming the vehicle's pose cannot be measured directly, it can be considered that it represents a hidden state in that dynamic system, and it can be estimated. There are different state estimation techniques/algorithms, depending on the adopted assumptions (linear system, Gaussian noise, etc.). Consequently, if the behavior of the system is modeled as linear, a Kalman Filter may be used. If it is modeled as non-linear, several options are available, like Extended Kalman Filter, Unscented Kalman Filter, Particle Filter, etc. In the present case, considering the system is non-linear and taking into account the required robustness of the estimation algorithm, a Particle Filter algorithm has been preferably selected.

In general terms, the estimation of the pose of the vehicle includes determining the segment or intersection where the vehicle is. At the beginning, this information is obtained considering that both, the topological map data and the initial position where the vehicle starts its movement, are known. After that, in each instant of time, several pieces of information are processed according to the particle filter algorithm: the current observation (e.g. sensor measurements), the observations stored in the observation map of the corresponding segment/intersection, and the previous pose of the vehicle. Afterwards, using this data, by applying the particle filter algorithm the vehicle's current pose within the segment/intersection is estimated.

The particle filter technique estimates the current position and the orientation of the vehicle by calculating the probability that current sensor data (observations) match previous sensor data (observations) obtained at certain positions and orientations within the particular segment/intersection. The possible position and orientation are continuous variables due the use of Gaussian Processes, which allow transforming the previous discrete data into continuous data. The vehicle's pose is the one that maximizes the matching probability. The estimation gives useful information about the proximity to the end of the segment.

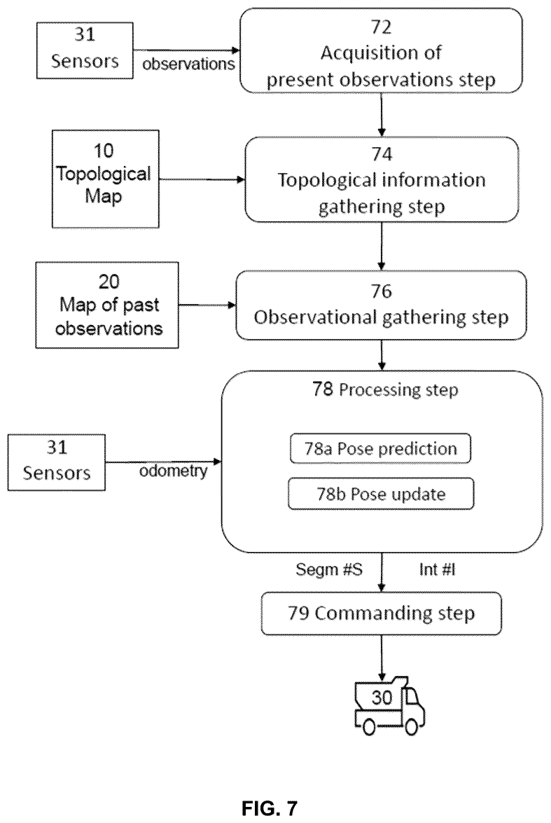

FIG. 7 shows a flow diagram for some of the steps encompassed by the method of navigation.

In an acquisition step 72, observations are presently acquired from discrete positions while driving the autonomous vehicle. The observations include surroundings information taken from sensors installed on the vehicle that measure properties of the environment such as height and curvature.

In a topological information gathering step 74, a topological map of the open-pit site is accessed to gather information about intersections and segments of the open-pit site.

In an observational gathering step 76, an observational map of the open-pit site is accessed to gather past surroundings information associated with intersections and with segments of the topological map.

In a processing step 78, past observations, current observations, and odometry information are processed by a processing unit that applies a particle filtering technique and Gaussian processes. The processing step 78 may include two sub-steps for a pose prediction 78a and a pose update 78b. Observations, which are generated from discrete positions, are modelled as a continuous variable.

In a commanding step 79, the autonomous vehicle is maneuvered. When it is in a segment, a moving-forward instruction and/or occasionally a steering instruction for keeping the autonomous vehicle within boundaries is issued. When it is in an intersection, a steering instruction to take a subsequent segment is issued.

The vehicle's current state is given by several sensors 31, typically internal sensors (e.g. odometers and/or inertial sensors) to obtain the vehicle's velocity and the angle of its front wheels, which are used for computing its odometry, in other words its displacement (cartesian pose difference) in each time step. The Pose Prediction sub-step 78a predicts the current pose based on the previous pose and the odometry. The pose update 78b takes as inputs the predicted pose together with the observation map and the current observations, and performs a consistency analysis and then to make a final estimation of the pose. This pose update sub-step 78b also determines if it is necessary to make a transition in the topological map (global pose) from one intersection/segment to another.

The observation map in each segment/intersection is updated periodically, considering that the characteristics of the pit are dynamic. For simplicity, this feature is not shown in the diagram shown in FIG. 7.

### Particle Filter Algorithm and Position Estimation in a Topological Map

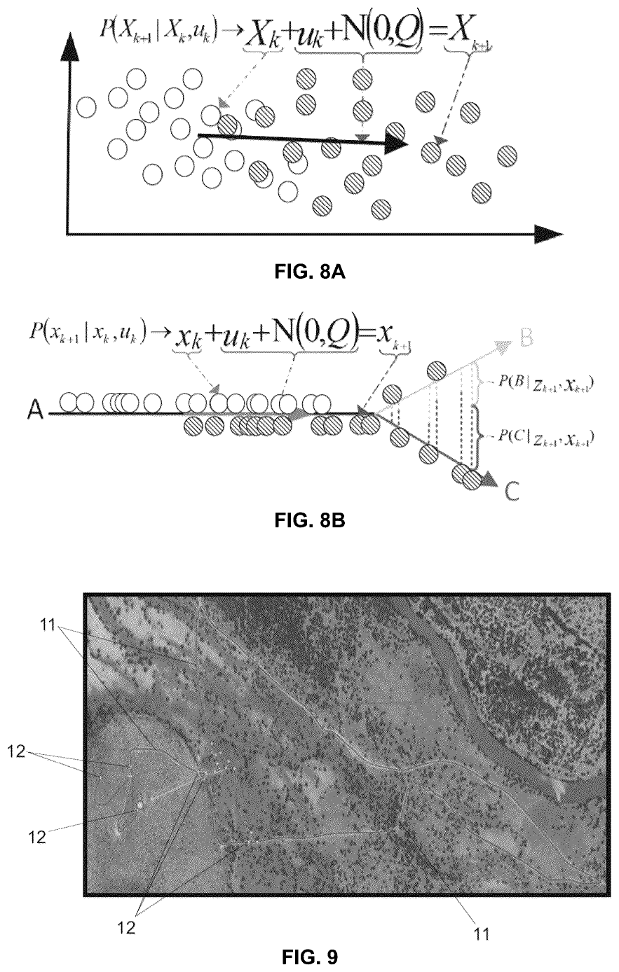

There are two improvements in the particle filter algorithm used.
A probabilistic model to distribute the particles, when approaching each intersection, in other words, to decide what particles go to each of the segments after the intersection (see FIG. 8(b)). The classical particle filters do not use this kind of models because they are applied in metric maps or feature maps, where intersections do not exist. Each one of the particles corresponds to a hypothesis or candidate of the (local) pose of the vehicle, and in a topological map is relevant to take a proper decision on how to distribute the particles when they are moved near an intersection in the prediction step of the filter.
The use of Gaussian Processes (they estimate mean and covariance of a data series in time or space) to estimate the probability of perceiving certain observations given the vehicle's current pose. This is important because the observation map only has observations stored in discrete positions, which reduce the required information to store, and the use of Gaussian Processes allows to calculate the probability of obtaining an observation in certain position, as if the position where a continuous variable.

As mentioned, when utilizing a topological map and modeling the pose of each particle as a global and local pose, it is not possible to utilize a traditional particle filter, because it has to be able to decide what to do with the particles in the intersections.

FIG. 8A shows a result of a traditional particle filter technique when it is applied to estimate the position in two dimensions, where each particle moves from its initial bidimensional pose xₖ, in the direction of movement uk, taking samples from the distribution of the motion noise model N(0, Q).

For motion noise model is meant the modeling of the errors that exists in the process of estimating the vehicle's movement.

For sample is meant that the new pose of a particle is a sample obtained by sampling a probability distribution.

The correspondence may be expressed as:

$$P ( {X}_{k + 1} \vert {X}_{k} , {u}_{k} ) \to {X}_{k} \text{?} {u}_{k} + N ( 0 , Q ) = \text{?} \qquad ( 0 )$$

$$\text{?} \text{indicates text missing or illegible when filed}$$

The white circles represent the pose of the particles before applying the prediction step in the current time step.

The striped circles represent the pose of the particles after applying the prediction step in the current time step.

FIG. 8B shows a result of how the proposed particle filter technique works for localizing an element (e.g. self-locating a vehicle) in a topological map. It can be seen that, similarly to the traditional filter, the particles, representing vehicles local poses, change from their original position xₖ (one dimensional) in the direction of movement uₖ, considering the variance of the movement, the term zₖ₊₁ corresponds to the observations. The particles cross an intersection when the vehicle is moving. Then, a decision must be made to select which segment to go, segment B or segment C. This selection is made using the probabilities P(B|zₖ₊₁, xₖ₊₁) and P(C|zₖ₊₁, xₖ₊₁). Each particle that crosses the intersection takes a sample that selects segment B or C with probabilities P(B|zₖ₊₁, xₖ₊₁) and P(C|zₖ₊₁, xₖ₊₁) respectively. To calculate these probabilities, the Bayes theorem is used:

$$P ( S \vert {z}_{k + 1} , {x}_{k + 1} ) = \frac{P ( {z}_{k + 1} \vert S , {x}_{k + 1} ) * P ( S \vert {x}_{k + 1} )}{P ( {z}_{k + 1} \vert {x}_{k + 1} )} \qquad ( 1 )$$

where the variable S (segment) can be Bor C.

In equation (1) it is important to notice that the term P(zₖ₊₁|xₖ₊₁) is independent of the segment and therefore it is common for both routes. On the other hand, it is assumed that the a priori probability of a segment does not depend on the current vehicle's pose, so that the term P(S|xₖ₊₁) can be replaced by P(S). For now, it is assumed that the a priori probability is uniform (P(S)=0.5). Nonetheless, other decision can be made, like giving higher probabilities to a planned segment. With these changes (1) can be calculated as follows:

$$P ( S \vert {z}_{k + 1} , {x}_{k + 1} ) = \frac{P ( {z}_{k + 1} \vert S , {x}_{k + 1} ) * P ( S )}{{\sum }_{R ∈ Segments} P ( {z}_{k + 1} \vert R , {x}_{k + 1} ) * P ( R )} \qquad ( 2 )$$

It is noteworthy that the divisor term in equation (2) is a normalization term.

To calculate P(zₖ|S, xₖ), Gaussian Processes are used, which model the mean and covariance of the observations stored in the observation map along each segment. Gaussian Processes are completely defined by their covariance function K(x, x′) or Kernel. Given a collection of observations X, Y, the mean and covariance in a point x* are given by equations (3) and (4):

$$mean ( {x}^{*} ) = {K ( X , {x}^{*} )}^{T} {K ( X , X )}^{- 1} Y \qquad ( 3 )$$

$$cov ( {x}^{*} ) = K ( {x}^{*} , {x}^{*} ) - {K ( X , {x}^{*} )}^{T} {K ( X , X )}^{- 1} K ( X , {x}^{*} ) \qquad ( 4 )$$

Then, for each observation z, in each segment S, a Gaussian Process is used to model the probability distribution of said observation as a function of the position x* (a continuous variable):

$$P ( z \vert S , {x}^{*} ) = \frac{1}{\sqrt{2 π {cov}_{s} ( {x}^{*} )}} {e}^{\frac{- {( {mean}_{S} ( {x}^{*} ) - z )}^{2}}{2 c o {v}_{S} ( {x}^{*} )}} \qquad ( 5 )$$

where meanₛ(x*) y covₛ(x*) are the functions of the mean and covariance of the Gaussian Process for segment S. Equation (5) is utilized in the pose update sub-step and in equation (2). In other words, P(z|S, x*) is the probability of observing z given that the particle (hypothesis of the vehicle's pose) is in segment S with position x.

These and other features, functions, and advantages that have been discussed can be achieved independently in various embodiments or may be combined in yet other embodiments.

### Proof of Concept with a Prototype

Experimental results obtained by a simplified prototype based on the present teachings are presented herein. The ability of the prototype to self-localize within the different segments was tested. The trial was validated in a particular region, utilizing an autonomous vehicle equipped with an array of sensors, including multiple lasers, video cameras, altimeter, magnetometer, IMU.

FIG. 9 shows actual roads in a sector of the Laguna Carén Park in Santiago City (Chile) where the proof of concept took place. Segments are in continuous line and the intersections are in white circles. Different paths where taken, going through almost all roads in each one of them, and varying the driving order.

From the 27 segments considered: 21 have a length between 20 m and 50 m, 5 segments have lengths between 100 m and 300 m, and 1 segment has a length of 3,300 m. From the 12 paths considered, 3 where utilized to train the system and the other 9 to validate it. For the construction of a database corresponding to the observation map, sensors data were obtained from altimeter, magnetometer and IMU. Additionally, a differential GPS was included, which was only utilized to evaluate the performance.

### Experimental Results

To measure the performance of the prototype, the predicted pose is compared with the corresponding pose of the ground truth (true position), obtained from the GPS and transformed to graph coordinate system.

The GPS information was used in the global map generation process. This information was not utilized at any point during the operation of the prototype, it was only used for its experimental evaluation.

Promising results were obtained for the prototype, as the following:
Localization root mean square error for the 9 paths was of 0.37 m²;
Percentage error, with respect to the distance traveled was of 0.087%.

These outcomes were considered promising and prove feasibility for developing the present invention. The additional evidence and information are merely for illustration purposes and should not be consider limiting of the scope of the invention.

1. A method for navigating an autonomous vehicle in an open-pit site comprising the steps of:
acquiring a plurality of observations (72) and odometry information, from a plurality of discrete poses while driving, using a plurality of sensors (31) installed on the autonomous vehicle (30), wherein an observation comprises surroundings information;
accessing a topological map (10) of the open-pit site and gathering topological information (74) stored therein, wherein the topological map comprises a plurality of intersections and a plurality of segments associated therewith, wherein a segment represents a path of a length to be traversed with lateral boundaries, wherein an intersection represents a junction of at least two segments, or a working area connected with at least a segment;
accessing an observational map (20) of the open-pit site and gathering past observations (76), wherein an observation comprises surroundings information associated with an intersection or a segment of the topological map (20);
processing, using a processor unit (33), past observations, acquired observations and odometry information, applying a particle filtering technique and Gaussian processes for modelling observations acquired from discrete poses as a continuous variable and estimating the current pose and according to a current direction of movement, statistically predicting a next pose of the autonomous vehicle;
commanding the autonomous vehicle (30) via actuators controlled by the processor unit (33), based on detecting whether the autonomous vehicle (30) is in a segment or in an intersection, and respectively command the autonomous vehicle (30) a moving-forward instruction to traverse the segment or a steering instruction to take a subsequent segment.

2. The method for navigating the autonomous vehicle in the open-pit site according to claim 1, wherein the observational map (20) of the open-pit site is updated with observations acquired during driving the autonomous vehicle.

3. The method for navigating the autonomous vehicle in the open-pit site according to claim 1, wherein commanding the autonomous vehicle (30) in a segment further comprises a steering instruction for keeping the autonomous vehicle (30) within segment boundaries based on the estimated current pose on or the predicted next pose.

4. The method for navigating the autonomous vehicle in the open-pit site according to claim 1, wherein, by applying Gaussian Processes, the processor unit (33) calculates mean and covariance of a plurality of past observations to estimate a probability distribution of acquired observations given current pose of the autonomous vehicle (30).

5. The method for navigating the autonomous vehicle in the open-pit site according to claim 1, wherein a current pose is calculated by applying the particle filtering technique and comparing acquired observations (72) while driving with samples of the probability distribution of past observations associated with a plurality of segments and intersections and estimating the current pose within the segment or intersection.

6. The method for navigating the autonomous vehicle in the open-pit site according to claim 5, wherein particles of the particle filtering technique represent vehicle's candidate poses and they are statistically associated to a segment B or a segment C, by computing the probability of being in segment B given the current estimation of the pose and the current observations, and the probability of being in segment C given the current estimation of the pose and the current observations.

7. The method for navigating the autonomous vehicle in the open-pit site according to claim 1, wherein the open-pit site is an open-pit mine.

8. A system for navigating an autonomous vehicle in an open-pit site comprising:
a plurality of sensors (31) installed on the autonomous vehicle (30) configured to acquire a plurality of observations (72) and odometry information, from a plurality of discrete poses while driving, wherein an observation comprises surroundings information;
a processor unit (33) configured to:
access a topological map (10) of the open-pit site and gathering topological information (74), wherein the topological map comprises a plurality of intersections and a plurality of segments associated therewith, wherein a segment represents a path of a length to be traversed with lateral boundaries, wherein an intersection represents a junction of at least two segments, or a working area connected with at least a segment;
access an observational map (20) of the open-pit site and to gather past observations (76) stored therein, wherein an observation comprises surroundings information associated with an intersection or a segment of the topological map (20);
process past observations, acquired observations and odometry information, applying a particle filtering technique and Gaussian processes for modelling observations acquired from discrete poses as a continuous variable and estimating the current pose and according to a current direction of movement, statistically predicting a next pose of the autonomous vehicle;
control actuators (32) based on detecting whether the autonomous vehicle (30) is in a segment or in an intersection, and respectively command the autonomous vehicle (30) a moving-forward instruction to traverse the segment or a steering instruction to take a subsequent segment.

9. The system for navigating the autonomous vehicle in the open-pit site according to claim 8, wherein the observational map (20) of the open-pit site is updated with observations acquired during driving the autonomous vehicle (30).

10. The system for navigating the autonomous vehicle in the open-pit site according to claim 8, wherein commanding the autonomous vehicle (30) in a segment further comprises a steering instruction for keeping the autonomous vehicle (30) within segment boundaries based on the estimated current pose on or the predicted next pose.

11. The system for navigating the autonomous vehicle in the open-pit site according to claim 8, wherein, by applying Gaussian Processes, the processor unit (33) calculates mean and covariance of a plurality of past observations to estimate a probability distribution of acquired observations given current pose of the autonomous vehicle (30).

12. The system for navigating the autonomous vehicle in the open-pit site according to claim 8, wherein the sensors are selectable among an odometer, a LIDAR, an altimeter, a magnetometer, a gyroscope.

13. The system for navigating the autonomous vehicle in the open-pit site according to claim 8, wherein the open-pit site is an open-pit mine.
